(19) United States
(12) Patent Application Publication
(10) Pub. No.: US 2018/0059874 A1
(43) Pub. Date: Mar. 1, 2018

(54) METHOD AND DEVICE FOR PROCESSING OPERATION

(71) Applicant: Beijing Xiaomi Mobile Software Co., Ltd., Beijing (CN)

(72) Inventors: Weiliang ZHANG, Beijing (CN); Xin Sui, Beijing (CN); Jiaqi Wang, Beijing (CN); Ronghua Jiang, Beijing (CN)

(73) Assignee: Beijing Xiaomi Mobile Software Co., Ltd.

(21) Appl. No.: 15/632,991

(22) Filed: Jun. 26, 2017

(30) Foreign Application Priority Data
Aug. 24, 2016 (CN) PCT/CN2016/096462

(51) Int. Cl. G06F 3/0481; G06F 3/0484; G06F 3/0488; G06F 9/54; G06F 3/0486

(52) U.S. Cl. CPC G06F 3/0481; G06F 3/04842; G06F 3/0486; G06F 3/04883; G06F 9/543; G06F 3/0488

(57) ABSTRACT

The present disclosure relates to a method and device for processing user operations. The method includes: displaying a Graphical User Interface (GUI) for exchanging for a processing object, the GUI including a control key for confirming the exchanging for the processing object; when receiving a three-dimensional touch operation on the control key, sending a transfer instruction to a server, the transfer instruction being configured to request the server to generate an order corresponding to the processing object, and subsequently transfer a resource from a first account to a second account, to exchange for the processing object; receiving a success response from the server; and displaying a prompt indicating the success response.

### CROSS-REFERENCE TO RELATED APPLICATIONS

This application is based upon and claims priority to International Application No. PCT/CN2016/096462, filed Aug. 24, 2016, the entire contents of which are incorporated herein by reference.

### TECHNICAL FIELD

The present disclosure generally relates to terminal technology and, more particularly, to a method and device for processing user operations.

### BACKGROUND

Terminals, such as smart phones and tablet computers, are electronic devices commonly used in people's daily life. One of the most popular functions of the terminals is ordering and paying for goods/services electronically. For example, a terminal may display a series of webpages for a user to initiate, confirm, and pay an order. However, this process requires the user to perform multiple operations on the terminal and switch among multiple webpages, and thus makes it cumbersome and time consuming to purchase the goods/services via the terminal.

### SUMMARY

According to a first aspect of the present disclosure, there is provided a method, comprising: displaying a Graphical User Interface (GUI) for exchanging for a processing object, the GUI including a control key for confirming the exchanging for the processing object; when receiving a three-dimensional touch operation on the control key, sending a transfer instruction to a server, the transfer instruction being configured to request the server to generate an order corresponding to the processing object, and subsequently transfer a resource from a first account to a second account, to exchange for the processing object; receiving a success response from the server; and displaying a prompt indicating the success response.

According to a second aspect of the present disclosure, there is provided a terminal, comprising: a processor; a memory for storing instructions executable by the processor; and a three-dimensional touch display screen connected with the processor, wherein the processor is configured to: display a Graphical User Interface (GUI) for exchanging for a processing object, the GUI including a control key for confirming the exchanging for the processing object; when receiving a three-dimensional touch operation on the control key, send a transfer instruction to a server, the transfer instruction being configured to request the server to generate an order corresponding to the processing object, and subsequently transfer a resource from a first account to a second account, to exchange for the processing object; receive a success response from the server; and display a prompt indicating the success response.

According to a third aspect of the present disclosure, there is provided a non-transitory computer-readable storage medium storing instructions that, when executed by a processor of a terminal, cause the processor to perform a method comprising: displaying a Graphical User Interface (GUI) for exchanging for a processing object, the GUI including a control key for confirming the exchanging for the processing object; when receiving a three-dimensional touch operation on the control key, sending a transfer instruction to a server, the transfer instruction being configured to request the server to generate an order corresponding to the processing object, and subsequently transfer a resource from a first account to a second account, to exchange for the processing object; receiving a success response from the server; and displaying a prompt indicating the success response.

It is to be understood that both the foregoing general description and the following detailed description are exemplary and explanatory only and are not restrictive of the present disclosure.

### BRIEF DESCRIPTION OF THE DRAWINGS

To explain the technical solutions in the embodiments of the present disclosure more clearly, hereinafter, the drawings required for describing the embodiments will be introduced simply. The drawings described below are only some embodiments in the present disclosure. For the person skilled in the art, other drawings may be obtained according to these drawings without inventive effort.

FIG. 1 is a schematic diagram illustrating a system for processing user operations, according to an exemplary embodiment.

FIG. 2 is a flowchart of a method for processing user operations, according to an exemplary embodiment.

FIG. 3 is a flowchart of a method for processing user operations, according to an exemplary embodiment.

FIG. 4 is a schematic diagram illustrating an interface for implementing the method shown in FIG. 3, according to an exemplary embodiment.

FIG. 5 is a schematic diagram illustrating an interface for implementing the method shown in FIG. 3, according to an exemplary embodiment.

FIG. 6 is a schematic diagram illustrating an interface for implementing the method shown in FIG. 3, according to an exemplary embodiment.

FIG. 7 is a flowchart of a method for processing user operations, according to an exemplary embodiment.

FIG. 8 is a schematic diagram illustrating a pre-authorized Graphic User Interface (GUI), according to an exemplary embodiment.

FIG. 9 is a block diagram of a device for processing user operations, according to an exemplary embodiment.

FIG. 10 is a block diagram of a device for processing user operations, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

First, several terms used in the present disclosure are defined as follows.

“Processing object”: a physical commodity or a virtual commodity that is exchangeable. The physical commodity is an article existing in the real world, including, but not limited to, a personal electronic device, a household item, a household appliance, food, clothing, etc. The virtual commodity is an article existing in a computer system, an online environment, or a virtual environment. For example, the virtual commodity includes, but is not limited to, an E-book, a game prop, a virtual gift, etc.

“Exchange”: a process of exchanging a first user's resource for a second user's processing object. The first user is called as a purchaser of the processing object, and the second user is called as a seller of the processing object. In various embodiments, “exchange” may refer to at least one of the following operations: converting, purchasing, and/or transaction.

“Resource”: an item having value that is represented in an electronic form and whose value is quantified by a number. Common resources include but are not limited to electronic currency, virtual credits, virtual levels, virtual props, virtual gears, virtual characters, etc. For example, the resources may be virtual gears or virtual characters owned by a player in a video or online game. As another example, the resource may be a balance in a user's online bank account. For illustrative purpose only, the following description assumes the resource to be an electronic currency.

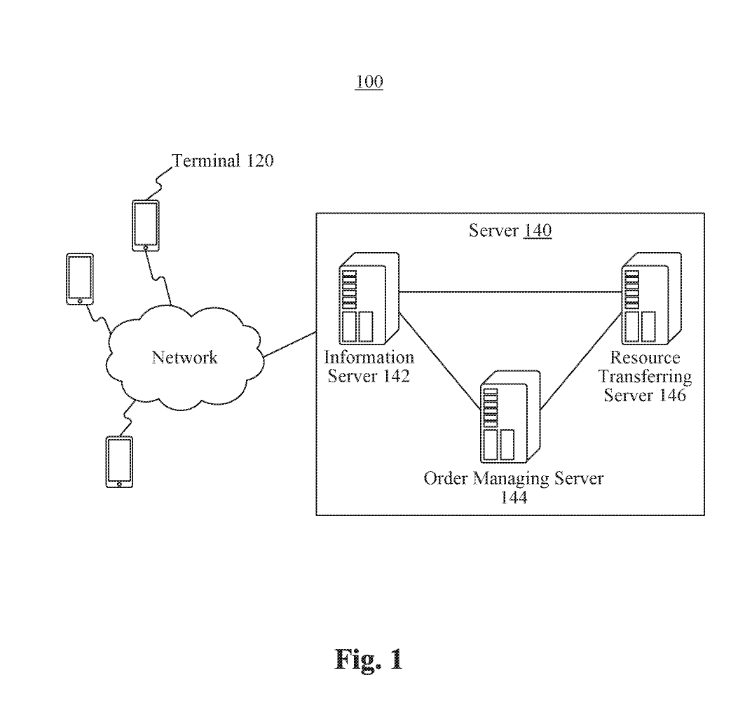

FIG. 1 is a schematic diagram illustrating a system 100 for processing user operations, according to an exemplary embodiment. Referring to FIG. 1, the system 100 includes a terminal 120 and a server 140.

The terminal 120 may be a mobile phone, a tablet computer, an E-book reader, a MP3 (Moving Picture Experts Group Audio Layer III) player, a MP4 (Moving Picture Experts Group Audio Layer IV) player, and the like. The terminal 120 runs client software for processing functions related to exchanging resources for processing objects. For example, the terminal 120 may be implemented as a purchasing terminal.

The terminal 120 is provided with a touch screen supporting a two-dimensional (2D) touch operation and/or a three-dimensional (3D) touch operation. That is, a user can use the 2D touch operation and/or the 3D touch operation to operate the terminal 120. The 2D touch operation is represented by an abscissa and an ordinate on the surface of the touch screen. The 3D touch operation is represented by an abscissa and an ordinate on the surface of the touch screen, as well as a pressure value indicative of pressure applied by the 3D touch operation on the touch screen. In the disclosed embodiments, the pressure applied by the 3D-touch operation is not necessarily perpendicular to the touch screen, and can be in any suitable direction.

Still referring to FIG. 1, the terminal 120 is connected to the server 140 via a wired or wireless network. The server 140 may be a server, a server cluster consisting of multiple servers, or a cloud computing service center. The server 140 is a back server for processing object exchanging based on user operations on the terminal 120. In some embodiments, the server 140 includes an information server 142, an order managing server 144, and a resource transferring server 146. The information server 142 is configured to manage information of processing objects, such as webpages showing the processing objects. The order managing server 144 is configured to generate and manage orders for purchasing the processing objects. Moreover, the resource transferring server 146 is configured to transfer resources between a first account and a second account. In some embodiments, the first account belongs to a purchaser of a processing object, and the second account belongs to a seller of the processing object or an intermediate account provided by the resource transferring server 146.

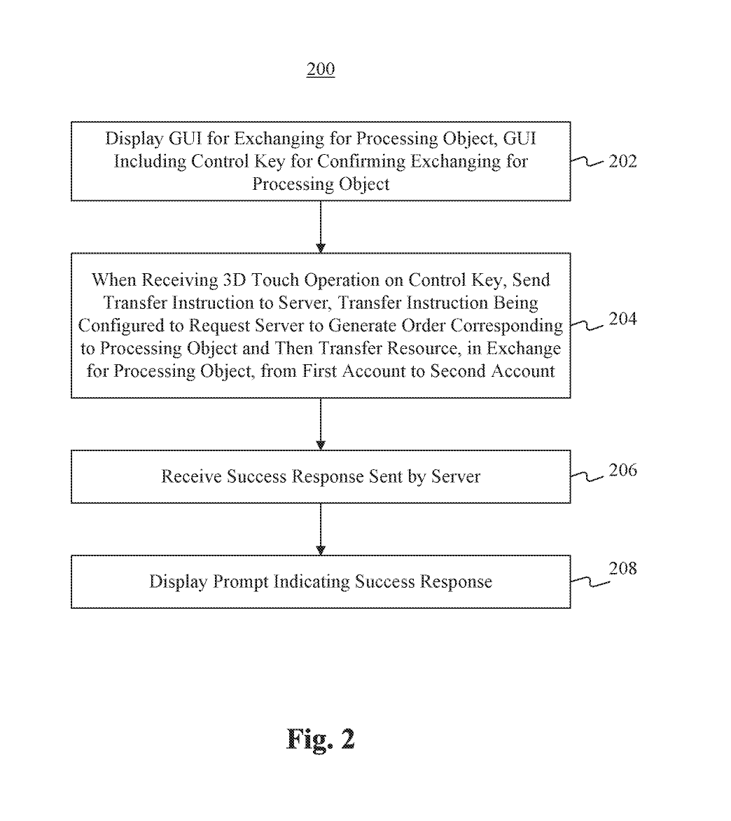

FIG. 2 is a flowchart of a method 200 for processing user operations, according to an exemplary embodiment. For illustrative purpose only, the method 200 is described as being implemented by the system 100 (FIG. 1) to exchange a resource for a processing object. Referring to FIG. 2, the method 200 includes the following steps 202-208.

In step 202, the terminal 120 displays, on a touch screen, a Graphic User Interface (GUI) for exchanging for a processing object. The GUI includes a control key for confirming the exchanging for the processing object.

In step 204, when receiving a 3D touch operation on the control key, the terminal 120 sends a transfer instruction to the server 140. The transfer instruction is configured to request the server 140 to generate an order corresponding to the processing object, and then transfer a resource, in exchange for the processing object, from a first account to a second account. In some embodiments, the 3D touch operation touches the touch screen at a pressure level higher than a predetermined threshold. In some embodiments, the first account is an account of a purchaser of the processing object, and the second account is an account of a seller of the processing object or an intermediate account managed by the resource transferring server 146.

In step 206, the terminal 120 receives a success response sent by the server 140.

In step 208, the terminal 120 displays a prompt indicating the success response.

According to the method 200, when a 3D touch operation is received at the control key, a transfer instruction is directly sent to a server. The server generates an order for the processing object according to the transfer instruction, and then transfers a resource from the first account to the second account, to exchange for the processing object. This way, the method 200 enables a user to generate and pay for an order using one 3D touch operation. As such, the method 200 solves the problem in the related art that multiple touch operations are needed to generate and pay for the order, and reduces the number of required user operations and the waiting time needed for switching among multiple GUIs. Therefore, the method 200 improves the operation efficiency of a terminal.

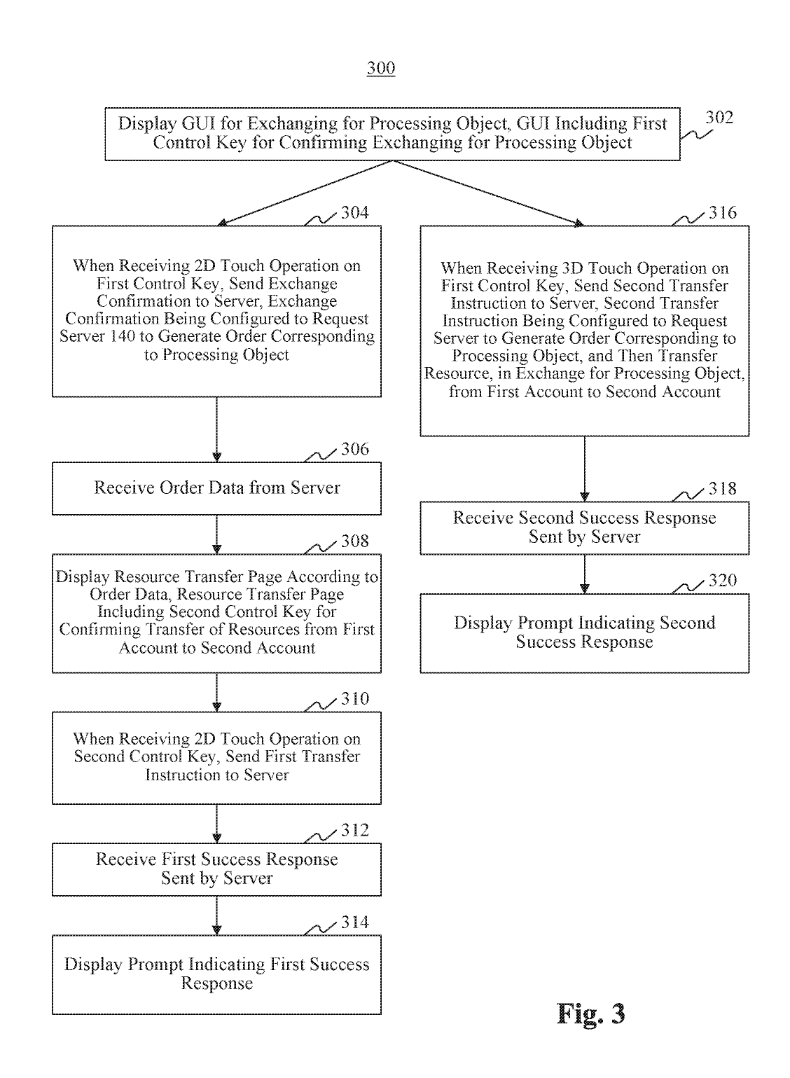

FIG. 3 is a flowchart of a method 300 for processing user operations, according to another exemplary embodiment. For illustrative purpose only, the method 300 is described as being implemented by the system 100 (FIG. 1) to exchange a resource for a processing object. Referring to FIG. 3, the method 300 includes the following steps 302-320.

In step 302, the terminal 120 displays a GUI for exchanging for a processing object. The GUI includes a first control key for confirming the exchanging for the processing object.

The terminal 120 is used by a first user. In some embodiments, the first user is a purchaser of the processing object. The first user can use the terminal 120 to log in a first user account associated with the first user. The terminal 120 acquires information of the processing object. The information includes: an identity and an exchanging value of the processing object. The exchanging value refers to the amount of the resource required for purchasing the processing object. In some embodiments, the information further includes: a name of the processing object, a category of the processing object, graphic and/or textual introduction information of the processing object, information regarding a second user account owning the processing object, and the like.

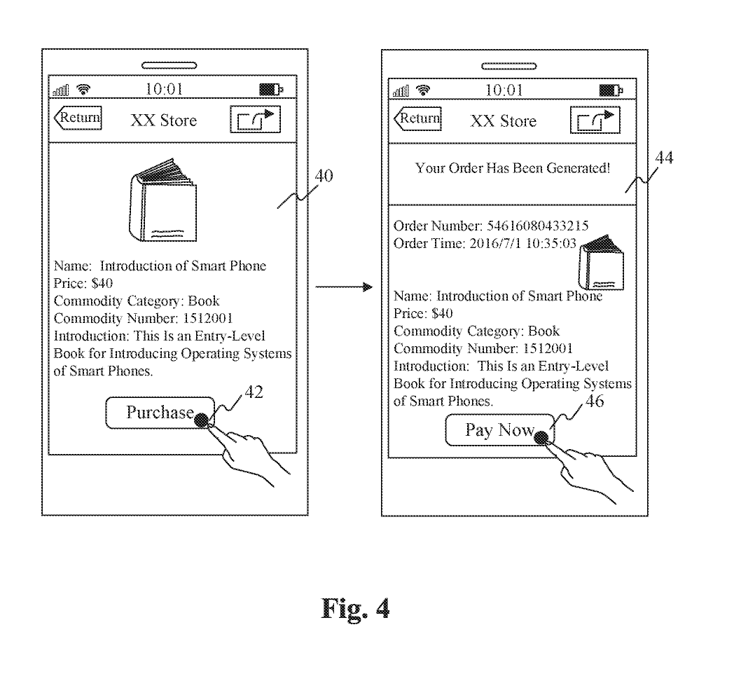

The GUI displays the information of the processing object and the first control key for confirming the exchanging of the processing object. FIG. 4 is a schematic diagram illustrating a GUI for implementing the method 300, according to an exemplary embodiment. Referring to FIG. 4, the terminal 120 displays a webpage 40. The webpage 40 indicates the following information: the name of a processing object—“Introduction of smart phone” (i.e., a paper or electronic book), the exchanging value (i.e., price) of the processing object—“$40,” the identity of the processing object—“1512001,” the category of the processing object—“Book,” the introduction information of the processing object—“This is an entry-level book for introducing operating systems of smart phones,” a second user account owning the processing object—“xx Bookstore”, and the first control key for confirming the exchanging of the processing object—as a button 42 shown as “Purchase.” In other embodiments, the button 42 may also be given other names, such as “Purchase now,” “Add into shopping cart,” etc.

Referring back to FIG. 3, in step 304, when receiving a 2D touch operation on the first control key, the terminal 120 sends an exchange confirmation to the server 140. The exchange confirmation is configured to request the server 140 to generate an order corresponding to the processing object.

The 2D touch operation is a touch operation that does not generate pressure on a touch screen of the terminal 120. Alternatively, the 2D touch operation may be a touch operation that applies pressure on the touch screen but the pressure does not exceed a predetermined threshold. The 2D touch operation causes the touch screen to generate a 2D touch signal. In some embodiments, the 2D touch signal indicates an abscissa and an ordinate of the 2D touch operation on the touch screen.

The touch screen then reports the generated 2D touch signal to a processor of the terminal 120. Upon receiving the 2D touch signal, the processor determines whether the 2D touch signal corresponds to a 2D touch operation performed on the first control key, based on the abscissa and ordinate indicated by the 2D touch signal. When it is determined that the corresponding 2D touch operation is performed on the first control key, the processor sends the exchange confirmation to the server 140.

The exchange confirmation is configured to request the server 140 to generate an order corresponding to the processing object. In some embodiments, the exchange confirmation includes the first user account associated with the first user, the identity of the processing object, the exchanging value of the processing object, the second user account owning the processing object, and a time stamp. For example, the exchange confirmation is configured to carry: “user1,” “article A,” “exchanging value $40,” “XX Bookstore,” and “10:35:03 2016-7-1.”

When receiving the exchange confirmation, the server 140 generates an order corresponding to the processing object according to the exchange confirmation. For example, the server 140 reads the first user account, the identity of the processing object, the exchanging value, the second user account, and the time stamp from the exchange confirmation, and generates an order according to the read information. In some embodiments, the generated order includes a unique order number.

After the generation of the order, the server 140 feeds back order data descriptive of the generated order to the terminal 120. The order data includes at least: the order number, the first user account, the identity of the processing object, the exchanging value, the second user account, and the time stamp. In some embodiments, the server 140 sends the order data to the terminal 120 in the form of a webpage or application (App) data.

In step 306, the terminal 120 receives the order data from the server 140.

In step 308, the terminal 120 displays a resource transfer page according to the order data. The resource transfer page includes a second control key for confirming transfer of resources from the first account to the second account.

Specifically, the terminal 120 displays the resource transfer page as a webpage or an App user interface. The resource transfer page includes the second control key for confirming the resource transfer.

As shown in FIG. 4, after receiving the order data from the server 140, the terminal 120 displays an order page 44. The order page 44 indicates an order number—“54616080433215,” the name of the processing object—“Introduction of smart phone”, the exchanging value—“$40”, the identity of the processing object—“1512001”, the category of the processing object—“Book”, the introduction information of the processing object—“This is an entry-level book for introducing operating systems of smart phones”, the second user account owning the processing object—“xx Bookstore”, and the second control key for confirming the resource transfer—as a button 46 shown as “Pay now.”

Referring back to FIG. 3, in step 310, when receiving a 2D touch operation on the second control key, the terminal 120 sends a first transfer instruction to the server 140.

Specifically, the 2D touch operation causes the touch screen to generate a 2D touch signal. In some embodiments, the 2D touch signal indicates an abscissa and an ordinate of the 2D touch operation on the touch screen.

The touch screen reports the 2D touch signal to the processor of the terminal 120. Upon receiving the 2D touch signal, the processor determines whether the 2D touch signal corresponds to a 2D touch operation performed on the second control key, based on the abscissa and ordinate indicated by the 2D touch signal. When it is determined that the corresponding 2D touch operation is performed on the second control key, the processor sends the first transfer instruction to the server 140.

In some embodiments, before sending the first transfer instruction to the server 140, the terminal 120 further prompts the first user to enter user authorization information, such as a password. Upon obtaining the user authorization information, the terminal 120 sends the first transfer instruction to the server 140.

The first transfer instruction is configured to request the server 140 to transfer a resource from the first account to the second account, to exchange for the processing object. In some embodiments, the first transfer instruction carries the order number, the first user account, the exchanging value, the second user account, the user authorization information, and a time stamp. For example, the first transfer instruction is configured to carry: “54616080433215,” “user1,” “exchanging value $40,” “XX Bookstore,” a payment password, and “10:35:06 2016-7-1.”

When receiving the first transfer instruction, the server 140 transfers the resource, in exchange for the processing object, from the first account to the second account, according to the first transfer instruction. After the resource is transferred, the server 140 sends a first success response to the terminal 120.

In some embodiments, the first user account is the same as the first account, and the second user account is the same as the second account. In some other embodiments, the first user account and the first account are different accounts, but have a binding relationship or are associated with each other. Similarly, the second user account and the second account may be different accounts, but have a binding relationship or are associated with each other.

In some embodiments, the second account is a resource account of a seller of the processing object, or an intermediate account provided by a resource transfer platform. If the second account is the intermediate account, when the purchase of the processing object is successful, the server 140 transfers the resource, in exchange for the processing object, from the intermediate account to the second account; while when the purchase of the processing object fails, the server 140 returns the resource from the intermediate account to the first account.

In step 312, the terminal 120 receives the first success response sent by the server 140.

In step 314, the terminal 120 displays a prompt indicating the first success response.

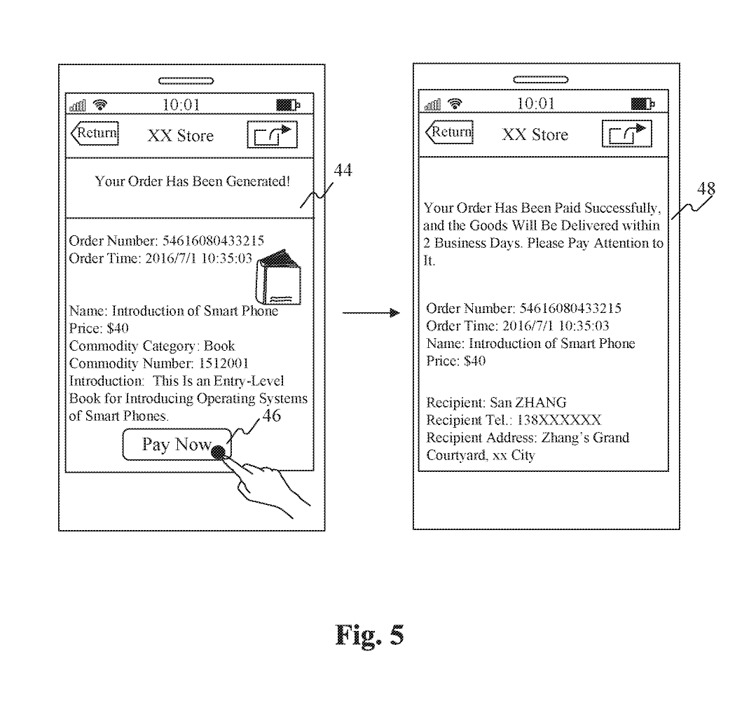

FIG. 5 is a schematic diagram illustrating the GUI for implementing the method 300, according to an exemplary embodiment. Referring to FIG. 5, after the button 46 shown as “Pay Now” on the order page 44 is pressed by the first user, the terminal 120 displays a response webpage 48 corresponding to the first success response. The response webpage 48 shows a prompt—“Your order has been paid successfully, and the goods will be delivered within 2 business days. Please pay attention to it.”

By implementing the above steps 304-314, the terminal 120 can exchange a resource for a processing object based on multiple 2D touch operations. As described below, the method 300 also includes the following steps 316-320 for purchasing a processing object based on a 3D touch operation. The steps 316-320 may be implemented in place of the steps 304-314.

Referring back to FIG. 3, in step 316, when receiving a 3D touch operation on the first control key, the terminal 120 sends a second transfer instruction to the server 140. The second transfer instruction is configured to request the server 140 to generate an order corresponding to the processing object, and then transfer a resource, in exchange for the processing object, from the first account to the second account.

The 3D touch operation is a touch operation that generates pressure on the touch screen. Alternatively, the 3D touch operation may be a touch operation that applies pressure on the touch screen and the pressure exceeds a predetermined threshold. The 3D touch operation causes the touch screen to generate a 3D touch signal. The 3D touch signal indicates an abscissa, an ordinate, and a pressure value of the 3D touch operation on the touch screen.

The touch screen then reports the 3D touch signal to the processor of the terminal 120. Upon receiving the 3D touch signal, the processor determines whether the 3D touch signal corresponds to a 3D touch operation performed on the first control key, based on the abscissa and ordinate indicated by the 3D touch signal. When it is determined that the 3D touch operation is performed on the first control key, the processor sends a second transfer instruction to the server 140.

The second transfer instruction is configured to request the server 140 to generate an order corresponding to the processing object, and then transfer a resource, in exchange for the processing object, from the first account to the second account. That is, the second transfer instruction accomplishes the functions of both the exchange confirmation and the first transfer instruction used in the case of 2D touch operations (steps 304-314). In some embodiments, the second transfer instruction carries the first user account, the identity of the processing object, the exchanging value of the processing object, the second user account, and a time stamp.

Upon receiving the second transfer instruction, the server 140 generates an order corresponding to the processing object based on the second transfer instruction, and then transfers the resource from the first account to the second account, to exchange for the processing object.

In step 318, the terminal 120 receives a second success response sent by the server 140.

In step 320, the terminal 120 displays a prompt indicating the second success response.

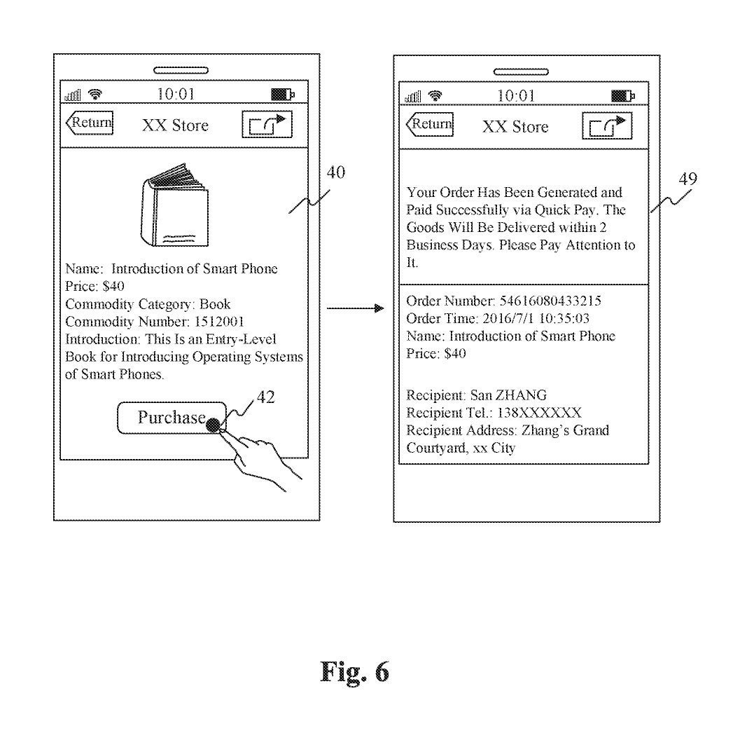

FIG. 6 is a schematic diagram illustrating the GUI for implementing the method 300, according to an exemplary embodiment. Referring to FIG. 6, after the button 42 shown as “Purchase” on the web page 40 is pressed, the terminal 120 displays a response webpage 49 corresponding to the second success response. The response webpage 49 shows the prompt—“Your order has been generated and paid successfully via quick pay. The goods will be delivered within 2 business days. Please pay attention to it.”

According to the method 300, when a 3D touch operation is received at the first control key, a transfer instruction is directly sent to a server. The server generates an order for the processing object according to the transfer instruction, and then transfers a resource from a first account to a second account, to exchange for the processing object. This way, the method 300 enables a user to generate and pay an order using one 3D touch operation. As such, the method 300 solves the problem in the related art that multiple touch operations are needed to generate and pay the order, and reduces the number of required user operations and the waiting time needed for switching among multiple GUIs. Therefore, the method 300 improves the operation efficiency of a terminal.

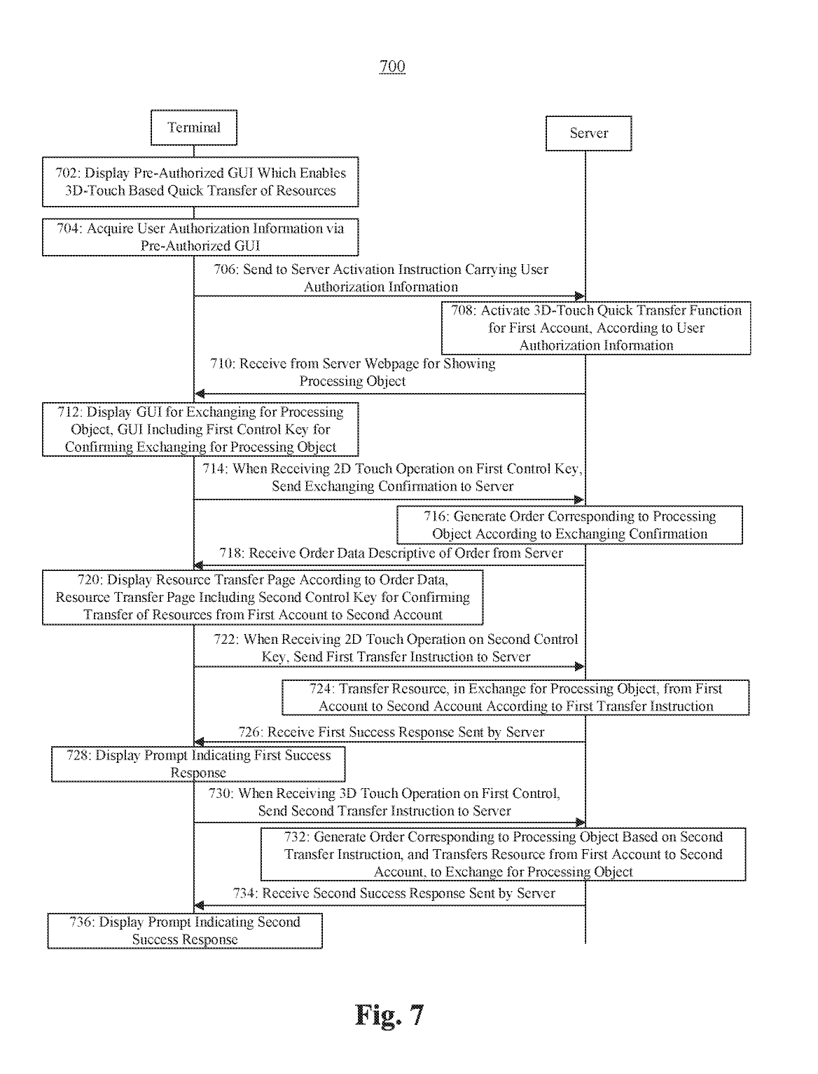

FIG. 7 is a flowchart of a method 700 for processing user operations, according to an exemplary embodiment. For illustrative purpose only, the method 700 is described as being implemented by the system 100 (FIG. 1) to exchange a resource for a processing object. Referring to FIG. 7, the method 700 includes the following steps 702-736.

In step 702, the terminal 120 displays a pre-authorized GUI which enables a 3D-touch based quick transfer of resources.

The terminal 120 is used by a first user, who is a purchaser of the processing object. The first user operates the terminal 120 to log in a first user account associated with the first user.

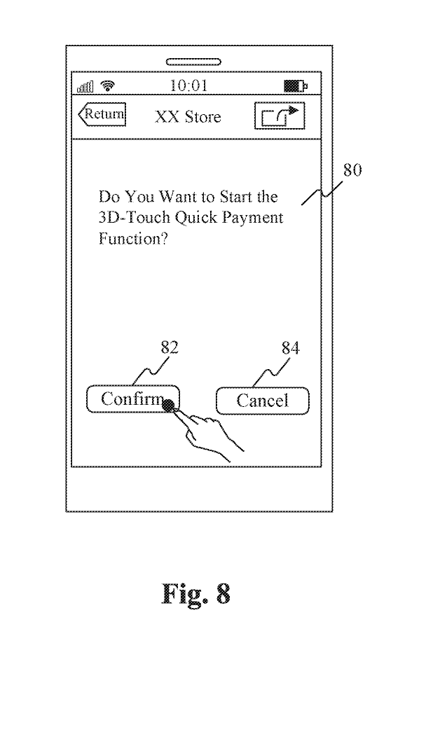

FIG. 8 is a schematic diagram illustrating a pre-authorized GUI 80, according to an exemplary embodiment. As shown in FIG. 8, the pre-authorized GUI 80 is displayed by the terminal 120 and shows a prompt—“Do you want to start the 3D-touch quick payment function,” a “Confirm” button 82, and a “Cancel” button 84.

Referring back to FIG. 7, in step 704, the terminal 120 acquires user authorization information via the pre-authorized GUI.

For example, referring to FIG. 8, after the first user clicks the “Confirm” button 82, the terminal 120 acquires the user authorization information via the pre-authorized GUI 80. The user authorization information includes but is not limited to a numerical password, a character password, a graphical password, a fingerprint password, a voice password, an iris password, and a combination of any two or more of these passwords. In some embodiments, the user authorization information is registered on the server 140 in advance.

Referring back to FIG. 7, in step 706, the terminal 120 sends to the server 140 an activation instruction carrying the user authorization information.

After acquiring the user authorization information, the terminal 120 generates the activation instruction carrying the user authorization information. The terminal 120 then sends the activation instruction to the server 140, e.g., the resource transferring server 146. The activation instruction is configured to instruct the resource transferring server 146 to activate the 3D-touch quick transfer function for the first account.

In step 708, the server 140 activates the 3D-touch quick transfer function for the first account, according to the user authorization information.

For example, the resource transferring server 146 stores one or more accounts and resources owned by each account. Upon receiving the activation instruction, the resource transfer server 146 verifies the user authorization information. If the verification is successful, the resource transfer server 146 activates the 3D-touch quick transfer function for the first account, and sends an activation success response to the terminal 120. If the verification fails, the resource transfer server 146 does not activate the 3D-touch quick transfer function for the first account, and sends an activation failure response to the terminal 120. The following description assumes the 3D-touch quick transfer function is activated successfully.

In step 710, the terminal 120 receives from the server 140 a webpage for showing the processing object.

The webpage shows various information regarding the processing object, including one or more of the following information fields: the identity of the processing object, the exchanging value of the processing object (i.e., the amount of the resource needed for purchasing the processing object), the name of the processing object, the category of the processing object, graphic and/or textual introduction information of the processing object, a second user account owning the processing object, and the like.

In step 712, the terminal 120 displays a GUI for exchanging for the processing object. The GUI includes a first control key for confirming the exchanging for the processing object. The GUI also includes at least one of the above information fields regarding the processing object.

In step 714, when receiving a 2D touch operation on the first control key, the terminal 120 sends an exchange confirmation to the server 140. The exchange confirmation is configured to request the server 140 to generate an order corresponding to the processing object.

The 2D touch operation is a touch operation that does not generate pressure on a touch screen of the terminal 120. Alternatively, the 2D touch operation may be a touch operation that applies pressure on the touch screen but the pressure does not exceed a predetermined threshold. The 2D touch operation causes the touch screen to generate a 2D touch signal. In some embodiments, the 2D touch signal indicates an abscissa and an ordinate of the 2D touch operation on the touch screen.

The touch screen then reports the generated 2D touch signal to a processor of the terminal 120. Upon receiving the 2D touch signal, the processor determines whether the 2D touch signal corresponds to a 2D touch operation performed on the first control key, based on the abscissa and ordinate indicated by the 2D touch signal. When it is determined that the corresponding 2D touch operation is performed on the first control key, the processor sends the exchange confirmation to the server 140.

The exchange confirmation is configured to request the server 140 to generate an order corresponding to the processing object. In some embodiments, the exchange confirmation includes the first user account associated with the first user, the identity of the processing object, the exchanging value of the processing object, the second user account owning the processing object, and a time stamp.

In step 716, the server 140 generates the order corresponding to the processing object according to the exchange confirmation.

The server 140 receiving the exchange confirmation may be the order managing server 144, which reads the first user account, the identity of the processing object, the exchanging value, the second user account, and the time stamp from the exchange confirmation, and generates the order according to the read information. In some embodiments, the generated order includes a unique order number.

After the generation of the order, the order managing server 144 feeds back order data descriptive of the generated order to the terminal 120. The order data includes at least: the order number, the first user account, the identity of the processing object, the exchanging value, the second user account, and the time stamp. In some embodiments, the order managing server 144 sends the order data to the terminal 120 in the form of a webpage or application data.

In step 718, the terminal 120 receives the order data sent by the server 140 (e.g., the order managing server 144).

In step 720, the terminal 120 displays a resource transfer page according to the order data. The resource transfer page includes a second control key for confirming transfer of resources from the first account to the second account.

Specifically, the terminal 120 displays the resource transfer page as a webpage or an App user interface. The resource transfer page includes the second control key for confirming the resource transfer.

In step 722, when receiving a 2D touch operation on the second control key, the terminal 120 sends a first transfer instruction to the server 140.

Specifically, the 2D touch operation causes the touch screen to generate a 2D touch signal. In some embodiments, the 2D touch signal indicates an abscissa and an ordinate of the 2D touch operation on the touch screen.

The touch screen reports the 2D touch signal to the processor of the terminal 120. Upon receiving the 2D touch signal, the processor determines whether the 2D touch signal corresponds to a 2D touch operation performed on the second control key, based on the abscissa and ordinate indicated by the 2D touch signal. When it is determined that the corresponding 2D touch operation is performed on the second control key, the processor sends the first transfer instruction to the server 140.

In some embodiments, before sending the first transfer instruction to the server 140, the terminal 120 further prompts the first user to enter user authorization information, such as a password. Upon obtaining the user authorization information, the terminal 120 sends the first transfer instruction to the server 140.

The first transfer instruction is configured to request the server 140 to transfer a resource from the first account to the second account, to exchange for the processing object. In some embodiments, the first transfer instruction carries the order number, the first user account, the exchanging value, the second user account, the user authorization information, and a time stamp.

In step 724, when receiving the first transfer instruction from the terminal 120, the server 140 transfers the resource, in exchange for the processing object, from the first account to the second account according to the first transfer instruction.

The server 140 receiving the first transfer instruction may be the resource transferring server 146. Upon receiving the first transfer instruction, the resource transferring server 146 interrogates the order managing server 144 to determine whether the order data carried by the first transfer instruction is correct. When the order data is determined to be correct, the resource transferring server 146 transfers the resource from the first account to the second account or an intermediate account, to exchange for the processing object.

In some embodiments, the first user account is the same as the first account, and the second user account is the same as the second account. In some other embodiments, the first user account and the first account are different accounts, but have a binding relationship or are associated with each other. Similarly, the second user account and the second account may be different accounts, but have a binding relationship or are associated with each other.

In some embodiments, the second account is a resource account of a seller of the processing object, or an intermediate account provided by a resource transfer platform. If the second account is the intermediate account, when the purchase of the processing object is successful, the server 140 transfers the resource, in exchange for the processing object, from the intermediate account to the second account; while when the purchase of the processing object fails, the server 140 returns the resource from the intermediate account to the first account.

After the resource transfer is successfully completed, the resource transferring server 146 sends a first success response to the terminal 120. In some embodiments, the resource transferring server 146 also sends a transfer success response to the order managing server 144, such that the order managing server 144 modifies the state of the order to indicate the order has been paid.

In step 726, the terminal 120 receives the first success response sent by the server 140.

In step 728, the terminal 120 displays a prompt indicating the first success response.

By implementing the above steps 714-728, the terminal 120 can exchange a resource for a processing object based on multiple 2D touch operations. As described below, the method 700 also includes the following steps 730-736 for purchasing a processing object based on a 3D touch operation. The steps 730-736 may be implemented in place of the steps 714-728.

In step 730, when receiving a 3D touch operation on the first control key, the terminal 120 sends a second transfer instruction to the server 140.

The second transfer instruction is configured to request the server 120 to generate an order corresponding to the processing object, and then transfer a resource from the first account to the second account, to exchange for the processing object.

The 3D touch operation is a touch operation that generates pressure on the touch screen. Alternatively, the 3D touch operation may be a touch operation that applies pressure on the touch screen and the pressure exceeds a predetermined threshold. The 3D touch operation causes the touch screen to generate a 3D touch signal. The 3D touch signal indicates an abscissa, an ordinate, and a pressure value of the 3D touch operation on the touch screen.

The touch screen then reports the 3D touch signal to the processor of the terminal 120. Upon receiving the 3D touch signal, the processor determines whether the 3D touch signal corresponds to a 3D touch operation performed on the first control key, based on the abscissa and ordinate indicated by the 3D touch signal. When it is determined that the corresponding 3D touch operation is performed on the first control key, the processor sends a second transfer instruction to the server 140, e.g., the order managing server 144.

The second transfer instruction is configured to request the server 140 to generate an order corresponding to the processing object, and then transfer a resource, in exchange for the processing object, from the first account to the second account. That is, the second transfer instruction accomplishes functions of both the exchange confirmation and the first transfer instruction used in the case of 2D touch operations (steps 714-728). In some embodiments, the second transfer instruction carries the first user account, the identity of the processing object, the exchanging value of the processing object, the second user account, and a time stamp.

In step 732, the server 140 generates an order corresponding to the processing object based on the second transfer instruction, and transfers the resource from the first account to the second account, to exchange for the processing object.

For example, the server 140 receiving the second transfer instruction may be the order managing server 144. Upon receiving the second transfer instruction, the order managing server 144 generates the order based on the second transfer instruction, and subsequently sends a transfer instruction to the resource transferring server 146. After receiving the transfer instruction, the resource transferring server 146 inquires whether the 3D-touch quick transfer function has been activated for the first user account. When it is determined that the 3D-touch quick transfer function has been activated, the resource transferring server 146 transfers the resource from the first account to the second account, to exchange for the processing object. After the transfer of the resource is successfully completed, the resource transferring server 146 sends a second success response to the terminal 120.

In step 734, the terminal 120 receives the second success response sent by the server 140.

In step 736, the terminal 120 displays a prompt indicating the second success response.

According to the method 700, when a 3D touch operation is received at the first control key, a transfer instruction is directly sent to a server. The server generates an order for the processing object according to the transfer instruction, and then transfers a resource from a first account to a second account, to exchange for the processing object. This way, the method 700 enables a user to generate and pay an order using one 3D touch operation. As such, the method 700 solves the problem in the related art that multiple touch operations are needed to generate and pay the order, and reduces the number of required user operations and the waiting time needed for switching among multiple GUIs. Therefore, the method 700 improves the operation efficiency of a terminal.

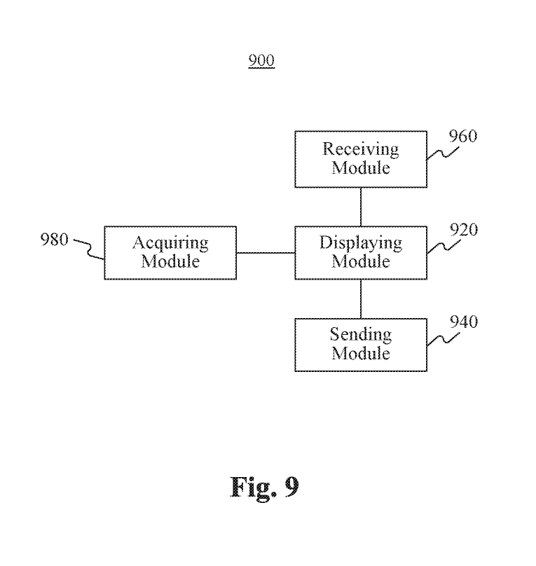

FIG. 9 is a block diagram of a device 900 for processing user operations, according to an exemplary embodiment. For example, the device 900 may process user operations to exchange a resource for a processing object. The device 900 may be implemented as the whole or a part of a terminal (e.g., the terminal 120) by software, hardware, or a combination of software and hardware. Referring to FIG. 9, the device 900 includes a displaying module 920, a sending module 940, and a receiving module 960.

The displaying module 920 is configured to display a GUI for exchanging for a processing object. The GUI includes a first control key for confirming the exchanging for the processing object.

The sending module 940 is configured to, when receiving a 3D touch operation on the first control key, send a first transfer instruction to a server. The first transfer instruction is configured to request the server to generate an order corresponding to the processing object, and then transfer a resource, in exchange for the processing object, from a first account to a second account.

The receiving module 960 is configured to receive a first success response sent by the server. Correspondingly, the displaying module 920 is further configured to display a prompt indicating the first success response.

In some embodiments, the sending module 940 is further configured to, when receiving a 2D touch operation on the first control key, send an exchange confirmation to the server. The exchange confirmation is configured to request the server to generate the order corresponding to the processing object. Correspondingly, the receiving module 960 is further configured to receive order data descriptive of the order from the server, and the displaying module 920 is further configured to display a resource transfer page according to the received order data. The resource transfer page includes a second control key for confirming the resource transfer.

In some embodiments, the sending module 940 is further configured to, when receiving a 2D touch operation on the second control key, send a second transfer instruction to the server. The second transfer instruction is configured to request the server to transfer the resource from the first account to the second account, to exchange for the processing object. Correspondingly, the receiving module 960 is further configured to receive a second success response sent by the server, and the displaying module 920 is further configured to display a prompt indicating the second success response.

In some embodiments, the displaying module 920 is further configured to display a pre-authorized GUI. The pre-authorized GUI is configured to enable a 3D-touch quick transfer function. Correspondingly, the device 900 further includes an acquiring module 980 configured to acquire user authorization information via the pre-authorized GUI. Moreover, the sending module 940 is configured to send an activation instruction including the user authorization information to the server. The activation instruction is configured to instruct the server to activate the 3D-touch quick payment function for the first account.

In some embodiments, the processing object is a commodity, the first control key is a purchase button, the resource is an electronic currency, the first account is a resource account of a purchaser of the processing object, and the second account is a resource account of a seller of the processing object or an intermediate account provided by a resource transfer platform.

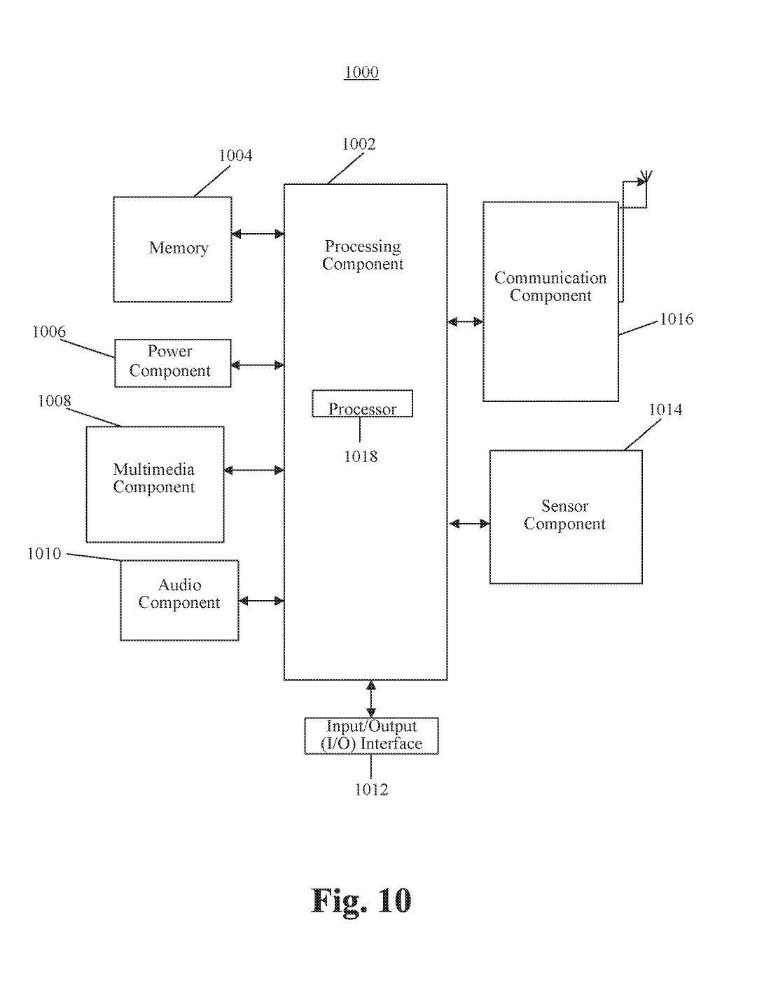

FIG. 10 is a block diagram of a device 1000 for processing user operations, according to an exemplary embodiment. For example, the device 1000 may be a terminal, such as a mobile phone, a computer, a digital broadcast terminal, a messaging device, a gaming console, a tablet, a medical device, exercise equipment, a personal digital assistant, and the like. Consistent with the disclosed embodiments, the device 1000 is configured to exchange a resource for a processing object.

Referring to FIG. 10, the terminal device 1000 includes one or more of the following components: a processing component 1002, a memory 1004, a power component 1006, a multimedia component 1008, an audio component 1010, an input/output (I/O) interface 1012, a sensor component 1014, and a communication component 1016.

The processing component 1002 typically controls overall operations of the device 1000, such as the operations associated with display, telephone calls, data communications, camera operations, and recording operations. The processing component 1002 includes one or more processors 1018 to execute instructions to perform all or some of the steps in the above described methods. Moreover, the processing component 1002 includes one or more modules which facilitate the interaction between the processing component 1002 and other components. For instance, the processing component 1002 may include a multimedia module to facilitate the interaction between the multimedia component 1008 and the processing component 1002.

The memory 1004 is configured to store various types of data to support the operation of the device 1000. Examples of such data include instructions for any applications or methods operated on the device 1000, contact data, phonebook data, messages, pictures, video, etc. The memory 1004 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1006 provides power to various components of the device 1000. The power component 1006 includes a power management system, one or more power sources, and any other components associated with the generation, management, and distribution of power in the device 1000.

The multimedia component 1008 includes a screen providing an output interface between the device 1000 and the user. In some embodiments, the screen includes a liquid crystal display (LCD) and/or a touch panel. If the screen includes the touch panel, the screen may be implemented as a touch screen to receive input signals from the user. The touch panel includes one or more touch sensors to sense touches, swipes, and gestures on the touch panel. In some embodiments, the touch sensors not only senses a boundary of a touch or swipe action, but also senses a period of time and a pressure associated with the touch or swipe action. In some embodiments, the multimedia component 1008 includes a front camera and/or a rear camera. The front camera and/or the rear camera receive an external multimedia data while the device 1000 is in an operation mode, such as a photographing mode or a video mode. Each of the front camera and the rear camera may be a fixed optical lens system or have focus and optical zoom capability.

The audio component 1010 is configured to output and/or input audio signals. For example, the audio component 1010 includes a microphone configured to receive an external audio signal when the device 1000 is in an operation mode, such as a call mode, a recording mode, and a voice recognition mode. The received audio signal may be further stored in the memory 1004 or transmitted via the communication component 1016. In some embodiments, the audio component 1010 further includes a speaker to output audio signals.

The I/O interface 1012 provides an interface between the processing component 1002 and peripheral interface modules, such as a keyboard, a click wheel, buttons, and the like. The buttons include, but are not limited to, a home button, a volume button, a starting button, and a locking button.

The sensor component 1014 includes one or more sensors to provide status assessments of various aspects of the device 1000. For instance, the sensor component 1014 may detect an open/closed status of the device 1000, relative positioning of components, e.g., the display and the keypad, of the device 1000, a change in position of the device 1000 or a component of the device 1000, a presence or absence of user contact with the device 1000, an orientation or an acceleration/deceleration of the device 1000, and a change in temperature of the device 1000. The sensor component 1014 may include a proximity sensor configured to detect the presence of nearby objects without any physical contact. The sensor component 1014 may also include a light sensor, such as a complementary metal oxide semiconductor (CMOS) or a charge coupled device (CCD) image sensor, for use in imaging applications. In some embodiments, the sensor component 1014 also includes an accelerometer sensor, a gyroscope sensor, a magnetic sensor, a pressure sensor, or a temperature sensor.

The communication component 1016 is configured to facilitate communication, wired or wirelessly, between the device 1000 and other devices. The device 1000 can access a wireless network based on a communication standard, such as WiFi, 2G, 3G, 4G, 5G, or a combination thereof. In one exemplary embodiment, the communication component 1016 receives a broadcast signal or broadcast associated information from an external broadcast management system via a broadcast channel In one exemplary embodiment, the communication component 1016 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 1000 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above-described methods.

In exemplary embodiments, there is also provided a non-transitory computer-readable storage medium including instructions, such as included in the memory 1004, executable by the processor 1018 to perform the above-described methods. For example, the non-transitory computer-readable storage medium may be a ROM, a random access memory (RAM), a CD-ROM, a magnetic tape, a floppy disc, an optical data storage device, and the like.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method, comprising:
displaying a Graphical User Interface (GUI) for exchanging for a processing object, the GUI including a control key for confirming the exchanging for the processing object;
when receiving a three-dimensional touch operation on the control key, sending a transfer instruction to a server, the transfer instruction being configured to request the server to generate an order corresponding to the processing object, and subsequently transfer a resource from a first account to a second account, to exchange for the processing object;
receiving a success response from the server; and
displaying a prompt indicating the success response.

2. The method of claim 1, wherein:
the control key is a first control key; and
the method further includes:
when receiving a two-dimensional touch operation on the first control key, sending an exchange confirmation to the server, the exchange confirmation being configured to request the server to generate the order corresponding to the processing object;
receiving order data descriptive of the order from the server; and
displaying a resource transfer page according to the order data, the resource transfer page including a second control key for confirming the transferring of the resource.

3. The method of claim 2, wherein:
the transfer instruction is a first transfer instruction, and the success response is a first success response; and
the method further includes:
when receiving a two-dimensional touch operation on the second control key, sending a second transfer instruction to the server, the second transfer instruction being configured to request the server to transfer the resource from the first account to the second account, to exchange for the processing object;
receiving a second success response from the server; and
displaying a prompt indicating the second success response.

4. The method of claim 1, further comprising:
displaying a pre-authorized GUI, the pre-authorized GUI having a three-dimensional-touch quick transfer function;
acquiring user authorization information via the pre-authorized GUI; and
sending an activation instruction to the server, the activation instruction including the user authorization information and being configured to request the server to activate the three-dimensional-touch quick transfer function for the first account.

5. The method of claim 2, further comprising:
displaying a pre-authorized GUI, the pre-authorized GUI having a three-dimensional-touch quick transfer function;
acquiring user authorization information via the pre-authorized GUI; and
sending an activation instruction to the server, the activation instruction including the user authorization information and being configured to request the server to activate the three-dimensional-touch quick transfer function for the first account.

6. The method of claim 3, further comprising:
displaying a pre-authorized GUI, the pre-authorized GUI having a three-dimensional-touch quick transfer function;
acquiring user authorization information via the pre-authorized GUI; and
sending an activation instruction to the server, the activation instruction including the user authorization information and being configured to request the server to activate the three-dimensional-touch quick transfer function for the first account.

7. The method of claim 1, wherein the processing object is a commodity, the first control key is a purchase button, the resource is an electronic currency, the first account is a resource account of a purchaser of the processing object, and the second account is at least one of a resource account of a seller of the processing object or an intermediate account provided by a resource transfer platform.

8. The method of claim 2, wherein the processing object is a commodity, the first control key is a purchase button, the resource is an electronic currency, the first account is a resource account of a purchaser of the processing object, and the second account is at least one of a resource account of a seller of the processing object or an intermediate account provided by a resource transfer platform.

9. The method of claim 3, wherein the processing object is a commodity, the first control key is a purchase button, the resource is an electronic currency, the first account is a resource account of a purchaser of the processing object, and the second account is at least one of a resource account of a seller of the processing object or an intermediate account provided by a resource transfer platform.

10. A terminal, comprising:
a processor;
a memory for storing instructions executable by the processor; and
a three-dimensional touch display screen connected with the processor,
wherein the processor is configured to:
display a Graphical User Interface (GUI) for exchanging for a processing object, the GUI including a control key for confirming the exchanging for the processing object;
when receiving a three-dimensional touch operation on the control key, send a transfer instruction to a server, the transfer instruction being configured to request the server to generate an order corresponding to the processing object, and subsequently transfer a resource from a first account to a second account, to exchange for the processing object;
receive a success response from the server; and
display a prompt indicating the success response.

11. The device of claim 10, wherein:
the control key is a first control key; and
the processor is further configured to:
when receiving a two-dimensional touch operation on the first control key, send an exchange confirmation to the server, the exchange confirmation being configured to request the server to generate the order corresponding to the processing object;
receive order data descriptive of the order from the server; and
display a resource transfer page according to the order data, the resource transfer page including a second control key for confirming the transferring of the resource.

12. The device of claim 11, wherein:
the transfer instruction is a first transfer instruction, and the success response is a first success response; and
the processor is further configured to:
when receiving a two-dimensional touch operation on the second control key, send a second transfer instruction to the server, the second transfer instruction being configured to request the server to transfer the resource from the first account to the second account, to exchange for the processing object;
receive a second success response from the server; and
display a prompt indicating the second success response.

13. The device of claim 10, wherein the processor is further configured to:
display a pre-authorized GUI, the pre-authorized GUI having a three-dimensional-touch quick transfer function;
acquire user authorization information via the pre-authorized GUI; and
send an activation instruction to the server, the activation instruction including the user authorization information and being configured to request the server to activate the three-dimensional-touch quick transfer function for the first account.

14. The device of claim 11, wherein the processor is further configured to:
display a pre-authorized GUI, the pre-authorized GUI having a three-dimensional-touch quick transfer function;
acquire user authorization information via the pre-authorized GUI; and
send an activation instruction to the server, the activation instruction including the user authorization information and being configured to request the server to activate the three-dimensional-touch quick transfer function for the first account.

15. The device of claim 12, wherein the processor is further configured to:
display a pre-authorized GUI, the pre-authorized GUI having a three-dimensional-touch quick transfer function;
acquire user authorization information via the pre-authorized GUI; and
send an activation instruction to the server, the activation instruction including the user authorization information and being configured to request the server to activate the three-dimensional-touch quick transfer function for the first account.

16. The device of claim 10, wherein the processing object is a commodity, the first control key is a purchase button, the resource is an electronic currency, the first account is a resource account of a purchaser of the processing object, and the second account is at least one of a resource account of a seller of the processing object or an intermediate account provided by a resource transfer platform.

17. The device of claim 11, wherein the processing object is a commodity, the first control key is a purchase button, the resource is an electronic currency, the first account is a resource account of a purchaser of the processing object, and the second account is at least one of a resource account of a seller of the processing object or an intermediate account provided by a resource transfer platform.

18. The device of claim 12, wherein the processing object is a commodity, the first control key is a purchase button, the resource is an electronic currency, the first account is a resource account of a purchaser of the processing object, and the second account is at least one of a resource account of a seller of the processing object or an intermediate account provided by a resource transfer platform.

19. A non-transitory computer-readable storage medium storing instructions that, when executed by a processor of a terminal, cause the processor to perform a method comprising:
displaying a Graphical User Interface (GUI) for exchanging for a processing object, the GUI including a control key for confirming the exchanging for the processing object;
when receiving a three-dimensional touch operation on the control key, sending a transfer instruction to a server, the transfer instruction being configured to request the server to generate an order corresponding to the processing object, and subsequently transfer a resource from a first account to a second account, to exchange for the processing object;
receiving a success response from the server; and
displaying a prompt indicating the success response.
